(19) United States
(12) Patent Application Publication
(10) Pub. No.: US 2004/0250461 A1
(43) Pub. Date: Dec. 16, 2004

(54) Remotely operated expandable and automatically contractible strutting tale decoy

(76) Inventor: Mark A. Dryer, Salina, KS (US)

Correspondence Address: Wright, Henson, Somers, Clark & Baker, LLP, Commerce Bank Building Downtown, 100 E. 9th Street, P.O. Box 3555, Topeka, KS, 66601-3555, US

(21) Appl. No.: 10/458,575

(22) Filed: Jun. 10, 2003

(51) Int. Cl. A01M 31/06

(52) U.S. Cl. 43/2

(57) ABSTRACT

A remotely operated mechanical strutting turkey tail decoy is disclosed having a rigid stake, a hinged strutting turkey tail, a cord for raising and lowering the tail while simultaneously opening and closing the tail.

### BACKGROUND

This invention relates to the art of hunting decoy's, in particular of those of the strutting turkey tail type.

It is well known that hunters utilize decoy's to gain the attention of and attract game. In the art of turkey hunting, it is typical for the hunter to place in a strategic location, static decoys that appear in different forms. These can be entire turkey decoys that consist of an entire body and tail with life like features; others may consist of only a fan tail. These fantails are typically static and are expanded only to assemble them and contract only for transporting purposes. While game are attracted to static decoys, it is desirable to have a moving or moveable decoy to provide even greater game attraction. It is even further desirable that the motion be responsive to the hunter, and be manageable from a remote location.

No known decoys exist that provide the ability for continued movement of a strutting turkey tail that moves as and when the hunter desires, and does so from a distance. Moreover, no such decoy exists that provides for continued open and closing of the tail and also provides for lowering of the tail to a natural position. In the latter situation, such lowering of the tail is consistent with the natural activities and behavior of turkeys to draw large male turkeys.

The instant invention provides for a sturdy, reliable, remotely operated strutting turkey tail that not only opens and closes in a fanning manner, but also raises and lowers in a natural life like manner, and such that the fanning out motion occurs gradually as the tail is raised, and further gradually closes as the tail is lowered. The sturdy design allows for remotely operating the invention with a string from a distance as far as 60 yards or greater. If a remote controlled motor is utilized, the distance is only limited to the transmitting distance of the transmitter. Furthermore, the design provides for a mechanism that is extremely responsive to a distant pull of the string. Still further, the invention can be utilized with most static turkey body decoys on the market to create an even more life like turkey.

Other objects and features of the invention and the manner in which the invention achieves its purpose will be appreciated from the foregoing and the following description and the accompanying drawings which exemplify the invention, it being understood that changes may be made in the specific method and apparatus disclosed herein without departing from the essentials of the invention set forth in the appended claims.

### BRIEF DESCRIPTION OF THE DRAWINGS:

FIG. 1 is a perspective showing the invention in an upright expanded mode.

FIG. 2 is a side view of the invention in the lowered position.

FIG. 3 is a close-up front view of the invention showing the relative positions of the assembly in the lowered position

FIG. 4a is a top view of the weighted slide

FIG. 4b. is a side view of the weighted slide

FIG. 5 is a side view of the assembly showing the stop 50

### DESCRIPTION OF THE PREFERRED EMBODIMENT

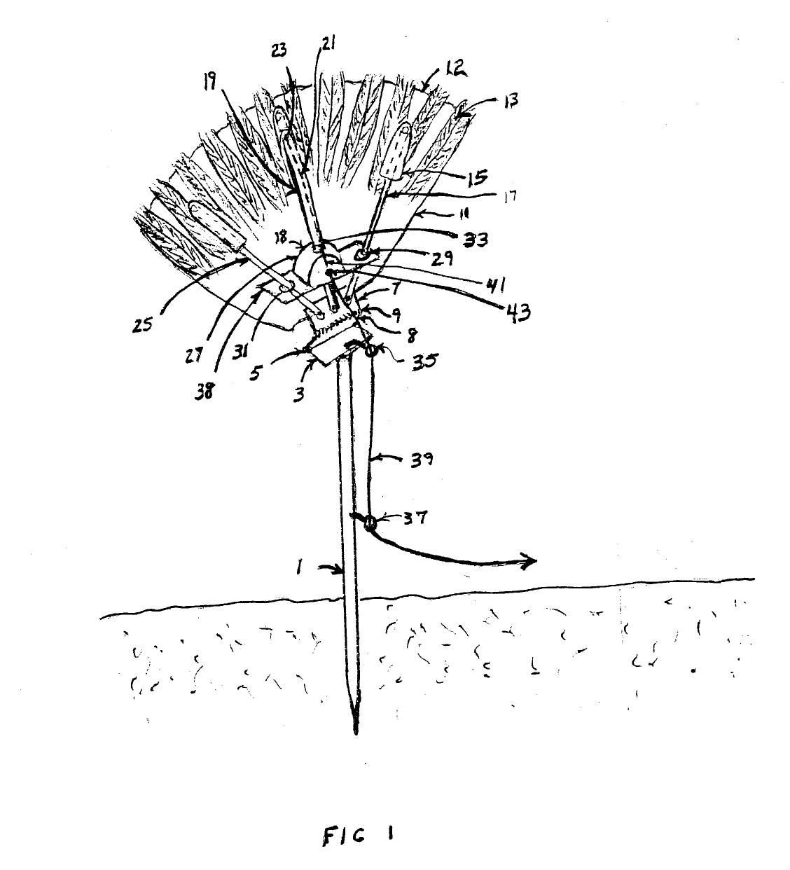

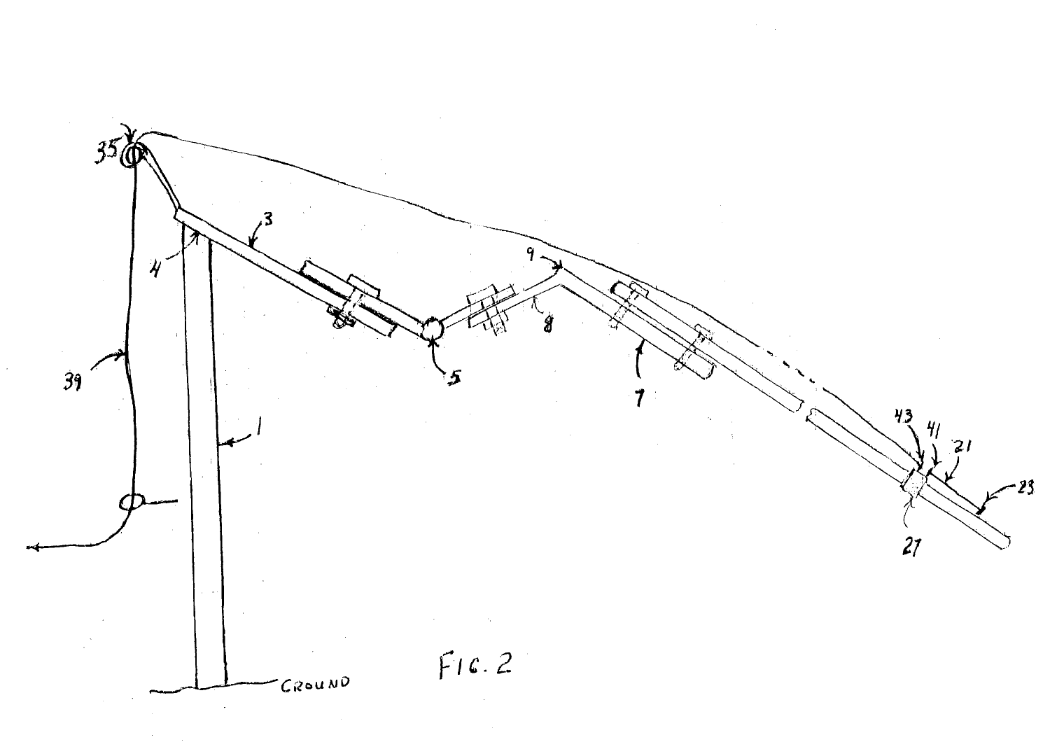

The invention is shown in the preferred mode in the perspective view in FIG. 1. The rigid support member 1 is pushed or driven into the ground so as to support the structure. This rigid member can also be inserted through a static turkey decoy body so as to give the appearance of a full turkey with fantails. The elongated rigid member 1 has a first end placed in the ground and an opposing second end attached to the assembly comprised of a base and several members. In the preferred mode, the base is a first rigid planar member 3. This rigid planar member is preferably attached at a slight angle as shown in FIG. 2 although it is not required to be placed at an angle. Rigid planar member 7 and rigid planar member 8 are at an angle with relation to each other as shown in FIG. 2 which may be constructed by bending a rigid planar member at 9. This angle between planar member 7 and planar member 8 is such that when the string is pulled the expanded fan raises to a proper life like level when pulled to an upright position; however, the angle is also necessary so that point 9 is sufficiently high and near the level of the pivot point established by eyelet 35 so as to allow the string 39 to pull the assembly upwards from the lowered position. The lowered position is generally, in operational mode, considered to be approximately 90 degrees to 135 degrees (in the preferred mode) from upright vertical, as if the fan were laying, in a closed position, on top of the turkey's back. It is only significant that the angle between member 8 and 9 be sufficient to allow the string to pull the assembly up from a dead lowered position, given the relationship of the string and eyelet and hinge.

Rigid planar members 7 and 8 are hingedly connected to the rigid planar member 3 via hinge 5. The overall relationship of the rigid planar members 7, 8, 9, 3, and the hinge 5 provides that, in the preferred mode, the entire assembly reaches its maximum upright position at approximately vertical orientation, or slightly less than vertical (towards the lowered position).

The string 39 is strung through eyelets 35 and 37 and attached to the weighted slide 27 at the eyelet 43. The weighted slide is comprised of two portions, a planar rigid member 38 and the upper weight 18 which in the preferred mode is shown as generally semicircular in shape. Rigid planar portion 38 has three holes 31, 33, and 29 which allow the two outwardmost rigid extensions 17 and 25, along with the middle rigid extension 19, to penetrate therethrough and allow for the weighted slide to move back and forth while spreading or pulling together the outward extensions.

The weight 18 on the weighted slide more easily enables the fan to fall to a lowered position when the sting tension is released. While the weight is not required, this weight provides for a more reliable operation.

The weighted slide is spring biased towards the outward ends of the extensions which spring bias in the preferred mode is shown utilizing rubber band or other elongated elastic or spring means 21 having two ends, one attached near the end of the middle extension at hook means 23, and the other end attached to hook or eyelet means 41 on the weighted extension. The three extensions 25, 19 and 17 support the turkey feather assembly 12 which assembly is comprised of, in the preferred mode, fabric or other webbing 11 having attached thereto a plurality of feathers, 13. The feather assembly 12 is removably connected to the extensions utilizing pockets such as is shown at 15. Other embodiments of the feather and webbing assembly are envisioned.

FIG. 2 shows the side version of the assembly when in the lowered position. There the angles and relationships of the rigid planar members 7, 8, and 3, are shown, as well as the relationship of the string through eyelet 35 to the bend 9.

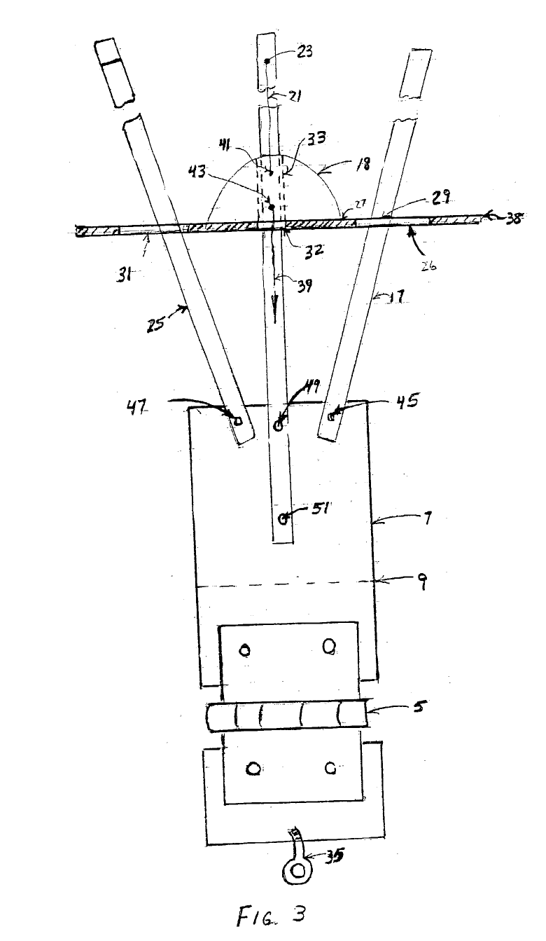

FIG. 3 shows the assembly from a top view when the assembly is in a lowered position. It can be seen that the outwardmost extensions 25 and 17 are brought together as the weighted slide 27 moves towards the end of the extensions, which movement is caused by the pulling of the elastic band 21 as the tension on string 39 is released.

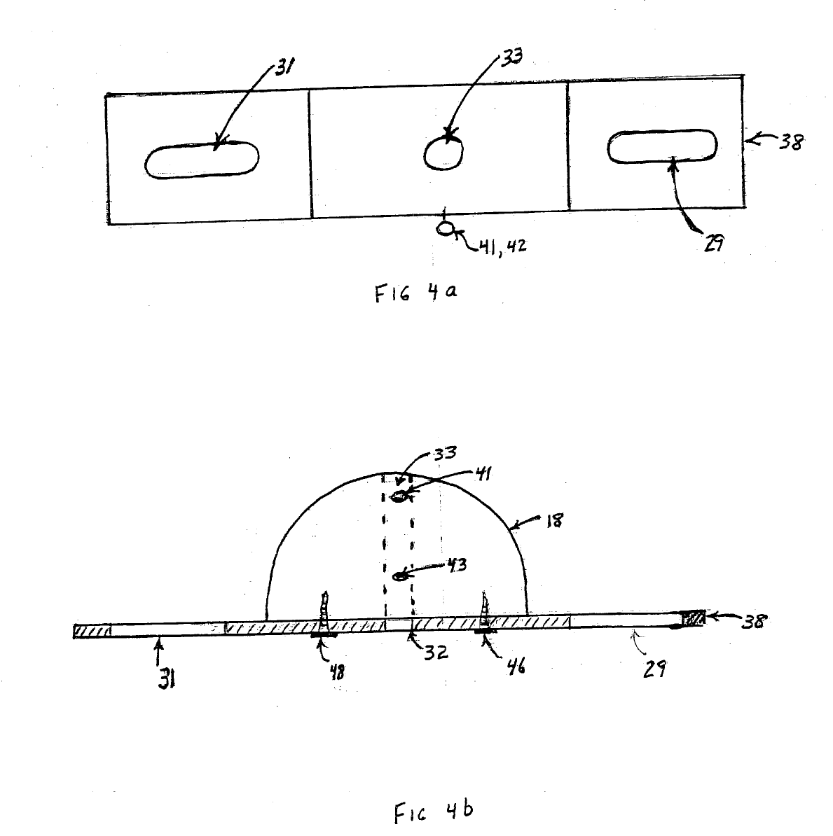

FIGS. 4a and 4b. show the top and side views, respectively of the weighted slide. It can be seen that the holes at each end of the rigid planar member 38 for the outwardmost rigid extensions are elongated so as to allow the extensions to move inward and outward as the weighted slide is moved up and down the middle extension via hole 33. Although the weighted slide is, in the preferred mode, any rigid structure, it is shown in FIG. 4a and 4b comprised of a rigid plate 38 attached via screws 46 and 48 to the semicircular portion 18. It should also be understood that the weighted slide can be of any shape, it only being significant that the weighted slide have means for bringing the outwardmost two extensions together as the assembly is lowered when the string tension is released or lessened sufficiently. In this mode, that is accomplished utilizing the elongated holes 29 and 31 in combination with the fact that the first ends on the outwardmost extensions are hingedly affixed to rigid planar member 7 and located closer together at 45 and 47 (FIG. 3) than are the holes 26 and 31.

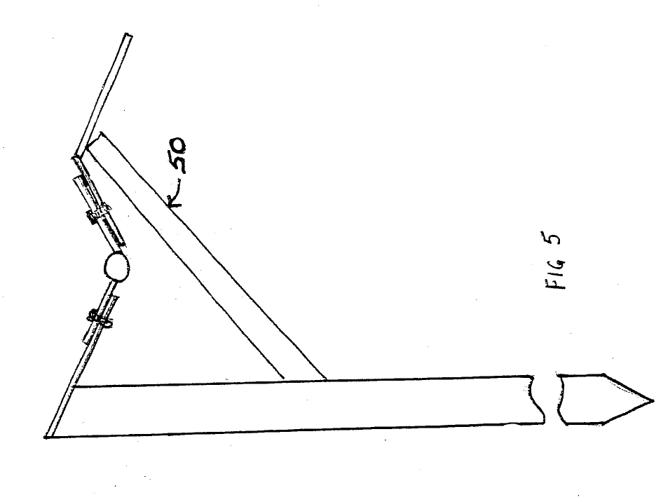

FIG. 5 shows a side view of the invention with stop means 50. While any stop means can be utilized to prevent the assembly from lowering too far below the pivot point established by the string and eyelet 8, the stop means 50 here are shown as a rigid member attached to the upright rigid support 1 as shown. This rigid member can be removable as well, or can be hingedly connected with fixing or locking means. When the invention is utilized with a turkey decoy, the fan assembly rests on the back of the turkey in the lowered position which naturally provides the stop means. This also provides for a more realistic and life like appearance.

It should also be understood that motor means can be utilized in combination with the string or other cable means to raise and lower the fantail assembly. In such a case, the motor can be operated remotely utilizing radio or other transmitter means.

In use, as indicated, the hunter drives the rigid support into the ground to create firm support sufficient to withstand the pulls of the string by the hunter at the desired remote distance. The hunter, lying in wait, can quietly pull and release the string at will, and in a desired amount, which correspondingly raises and lowers the fantails at the same time as the fantails are opened and closed respectively. This, particularly in combination with other static decoys, creates a more natural setting and provides a far more enticing and attractive decoy spread to the target game.

While there have been shown and described particular embodiments of the invention, it will be obvious to those skilled in the art that changes and modifications may be made without departing from the invention or its equivalent, and, therefore, it is intended by the appended claims to cover all such changes and modifications as fall within the true spirit and scope of the invention.

I claim:

1. A remotely operated mechanical strutting turkey tail decoy comprised of:
a. strutting turkey tail decoy;
b. rigid stake means;
c. hinge means between the strutting turkey tail so as to allow the turkey tail to be raised and lowered between a lowered position and an approximately upright position;
d. means for remotely moving the strutting turkey tail between the upright and lowered positions;

2. The remotely operated mechanical strutting turkey tail decoy in claim 1 wherein the means for remotely moving the strutting turkey tail to an upright position are comprised of cord means having one end attached to the strutting turkey tail so as to allow the strutting turkey tail to be pulled to the upright position in a spread out fashion.

3. The remotely operated mechanical strutting turkey tail decoy in claim 2 having tension means to tension bias the strutting turkey tail against the upright position such that the strutting turkey tail, when pulled by the cord to the upright position, is tension biased to the lowered position so as to allow the strutting turkey tail to automatically return to the lowered position when the cord is released.

4. The remotely operated mechanical strutting turkey decoy in claim I wherein the strutting turkey tail opens and closes, and further having cord means remotely opening and closing the strutting turkey tail.

5. The remotely operated mechanical strutting turkey tail decoy in claim 4 having means for simultaneously opening the strutting turkey tail when bringing the strutting turkey tail to an upright position.

6. The remotely operated mechanical strutting turkey tail decoy in claim 5 where the remote means for pulling the strutting turkey tail to an upright position are the same as the means for opening the strutting turkey tail.

7. The remotely operated mechanical strutting turkey tail decoy in claim 5 having means for automatically returning the strutting turkey tail to a closed position when the strutting turkey tail is lowered.

8. The remotely operated mechanical strutting turkey tail decoy in claim 5 where the means for opening the strutting turkey tail are comprised of a combination of elongated rods connected to the strutting turkey tail and slidably connected to a rigid slide member encompassing said rods and connected to the cord such that pulling of the cord causes movement of the rigid slide member to spread the rods and the connected strutting turkey tail outward.

9. The remotely operated mechanical strutting turkey tail decoy in claim 7 having tension bias means for tension biasing the movement of the slide plate towards the closed strutting turkey tail position.

10. The remotely operated mechanical turkey tail decoy in claim 5 where the means for remotely opening the strutting turkey tail are comprised of:
a. an elongated center rod attached to the strutting turkey tail, said rod having an outer end and a base end, wherein the base end is attached to a rigid hinge member;
b. two elongated outer rods, each having an outer end and a base end, whereby the said rods are attached to the rigid hinge member in an angularly displaced fashion with respect to the center rod, and whereby the said outer rods are also attached to the strutting turkey tail;
c. a base slide plate having a center hole and for receiving the center rod, an elongated outer hole on either side for receiving the two outer rods, such that movement of the slide plate up and down the center rod causes the outer rods and the attached strutting turkey tail to spread in and out respectively.

11. The remotely operated mechanical strutting turkey tail decoy in claim 9 having biased tension means for biasing the strutting turkey tail in a closed position, whereby said tension means are comprised of an elastic cord having two ends, one end attached near the outer end of the center rod and the other end attached to the base slide plate so as to bias the base slide plate towards the outer end of the center rod.
